(19) United States
(12) Patent Application Publication
(10) Pub. No.: US 2024/0069564 A1
(43) Pub. Date: Feb. 29, 2024

(54) INFORMATION PROCESSING DEVICE, INFORMATION PROCESSING METHOD, PROGRAM, AND MOBILE APPARATUS

(71) Applicant: SONY GROUP CORPORATION, TOKYO (JP)

(72) Inventor: TAICHI YUKI, TOKYO (JP)

(21) Appl. No.: 18/261,333

(22) PCT Filed: Dec. 16, 2021
(86) PCT No.: PCT/JP2021/046500

§ 371 Date: Jul. 13, 2023

(30) Foreign Application Priority Data
Jan. 22, 2021 (JP) 2021-009160

(51) Int. Cl. G05D 1/02

(52) U.S. Cl. CPC G05D 1/0274; G05D 1/0272

(57) ABSTRACT

A map used by a mobile apparatus is satisfactorily created.

The map creation unit creates at least a first map and a second map on the basis of a first recognition result of a surrounding environment. The created map switching determination unit determines an end of creation of the first map and a start of creation of the second map on the basis of a second recognition result of a surrounding environment. Since the map used in the mobile apparatus is divided on the basis of the surrounding environment, management and update can be performed satisfactorily. For example, the created map switching determination unit may determine the end of creation of the first map and the start of creation of the second map further on the basis of a creation status of the map in the map creation unit or further on the basis of a user operation.

### TECHNICAL FIELD

The present technology relates to an information processing device, an information processing method, a program, and a mobile apparatus, and more particularly relates to an information processing device and the like capable of satisfactorily creating a map used in the mobile apparatus.

### BACKGROUND ART

Conventionally, for example, in a mobile apparatus as an autonomous mobile body such as a robot or a car, a mobile apparatus that moves while performing self-position estimation is known. In this case, the mobile apparatus performs processing of matching with a self-position estimation map created in advance, estimates where the mobile apparatus is in the map, and controls movement on the basis of the result. In this case, it may be difficult to have a wide range of maps or to develop the maps on a memory depending on the performance of the mobile apparatus.

Accordingly, it is conceivable that the self-position estimation map is divided into and held in a map of a narrow range, and only a map near the self-position is developed on the memory. In this case, it is also easy to manage and update the self-position estimation map. However, it is difficult to understand how to divide, and when the self-position estimation map is simply divided, an efficient map configuration is not obtained. For example, during movement using the self-position estimation map, the map is frequently switched and a stop is required at the time of switching, or a load increases at the time of switching.

For example, Patent Document 1 discloses that a self-position estimation map is simply grid-divided and held on a map of a narrow range.

### CITATION LIST

### Patent Document

Patent Document 1: Japanese Patent Application Laid-Open No. 2009-163156

### SUMMARY OF THE INVENTION

### Problems to be Solved by the Invention

An object of the present technology is to satisfactorily create a map used in a mobile apparatus.

### Solutions to Problems

A concept of the present technology resides in an information processing device including:
a map creation unit that creates at least a first map and a second map on the basis of a first recognition result of a surrounding environment; and
a created map switching determination unit that determines an end of creation of the first map and a start of creation of the second map on the basis of a second recognition result of a surrounding environment.

In the present technology, the map creation unit creates at least the first map and the second map on the basis of the first recognition result of the surrounding environment. For example, the first map and the second map may be maps of adjacent regions. In addition, for example, each of the first map and the second map may be a map whose range is a region having similar environmental information. Further, for example, the map created by the map creation unit may be a self-position estimation map.

The created map switching determination unit determines the end of creation of the first map and the start of creation of the second map on the basis of the second recognition result of the surrounding environment. For example, the second recognition result may include a change amount of a current light color tone. In addition, for example, the second recognition result may include a change amount of a current distance to a surrounding object. Further, for example, the second recognition result may include a change amount of a current vibration amount. In addition, for example, the second recognition result may include a change amount of a current inclination.

As described above, in the present technology, the end of creation of the first map and the start of creation of the second map is determined on the basis of the recognition result of the surrounding environment. Therefore, since the map used in the mobile apparatus is divided on the basis of the surrounding environment, management and update can be performed satisfactorily.

Note that, in the present technology, for example, the created map switching determination unit may determine the end of creation of the first map and the start of creation of the second map further on the basis of a creation status of the map in the map creation unit. Thus, since the map used by the mobile apparatus is divided further on the basis of the creation status of the map, for example, a map having a size suitable for performance (map switching speed performance, map deployment performance on a memory, or the like) of the mobile apparatus can be created.

In this case, the creation status of the map may include a creation amount of the map. Then, here, for example, the creation amount of the map may be determined on the basis of a distance traveled to create a current map of a mobile apparatus including the information processing device. In addition, here, for example, the creation amount of the map may be determined on the basis of a data amount of a currently created map. Further, in this case, the creation status of the map may include a node arrangement instruction by a user.

In addition, in the present technology, for example, the created map switching determination unit may determine the end of creation of the first map and the start of creation of the second map further on the basis of a user operation. Thus, the map used in the mobile apparatus is divided on the basis of the intention of the user, and the map configuration can be as intended by the user.

In addition, the present technology may further include, for example, a map holding unit that holds a plurality of maps including at least the first map and the second map, a used map switching determination unit that switches the plurality of maps on the basis of a change in a surrounding environment, and a self-position estimation unit that estimates a self-position on the basis of the map used. This makes it possible to appropriately switch the map used for self-position estimation on the basis of a change in the surrounding environment.

Furthermore, another concept of the present technology resides in an information processing method including:
a mapping procedure of creating at least a first map and a second map on the basis of a first recognition result of a surrounding environment; and
a created map switching determination procedure of determining completion of creation of the first map and start of creation of the second map on the basis of a second recognition result of a surrounding environment.

Furthermore, another concept of the present technology resides in a program causing a computer to function as:
a map creation unit that creates at least a first map and a second map on the basis of a first recognition result of a surrounding environment; and
a created map switching determination unit that determines an end of creation of the first map and a start of creation of the second map on the basis of a second recognition result of a surrounding environment.

Furthermore, another concept of the present technology resides in a mobile apparatus including an information processing device, in which
the information processing device includes:
a map creation unit that creates at least a first map and a second map on the basis of a first recognition result of a surrounding environment; and
a created map switching determination unit that determines an end of creation of the first map and a start of creation of the second map on the basis of a second recognition result of a surrounding environment.

### BRIEF DESCRIPTION OF DRAWINGS

FIG. 1 is a block diagram illustrating a configuration example of a vehicle control system that is an example of a mobile apparatus control system to which the present technology can be applied.

FIG. 2 is a diagram illustrating an example of a sensing area by an external recognition sensor.

FIG. 3 is a block diagram illustrating a configuration example of a map creation processing unit in a self-position estimation system of a mobile apparatus as an autonomous mobile body such as a robot or a car.

FIG. 4 is a diagram for describing an example of a case where a self-position estimation map is created in an implementation environment in which one room A and one room B having different surrounding environments are connected by doors.

FIG. 5 is a diagram for describing an outline of a process of creating the self-position estimation map according to the present technology.

FIG. 6 is a diagram for describing an example of a process of creating the self-position estimation map in a case where the implementation environment is a shopping mall.

FIG. 7 is a diagram for describing an example of a process of creating the self-position estimation map in a case where the implementation environment is a road and a parking space adjacent thereto.

FIG. 8 is a diagram for describing an example of a process of creating the self-position estimation map in a case where the implementation environment is two construction sites and a slope connecting the two construction sites.

FIG. 9 is a diagram for describing an example of a process of creating the self-position estimation map in a case where the implementation environment is an office.

FIG. 10 is a diagram for describing an example of a process of creating the self-position estimation map in a case where the implementation environment is a factory.

FIG. 11 is a diagram illustrating an example of regions divided in each implementation environment and sensors used for dividing the regions.

FIG. 12 is a flowchart illustrating an outline of a map creation operation by a map creation processing unit.

FIG. 13 is a block diagram illustrating a configuration example of a self-position estimation processing unit in the self-position estimation system of the mobile apparatus as an autonomous mobile body such as a robot or a car.

FIG. 14 is a block diagram illustrating a configuration example of hardware of a computer.

### MODE FOR CARRYING OUT THE INVENTION

Hereinafter, a mode for carrying out the invention (hereinafter referred to as an “embodiment”) will be described. Note that description will be provided in the following order.
1. Configuration example of vehicle control system
2. Embodiment
3. Modification

### 1. Configuration Example of Vehicle Control System

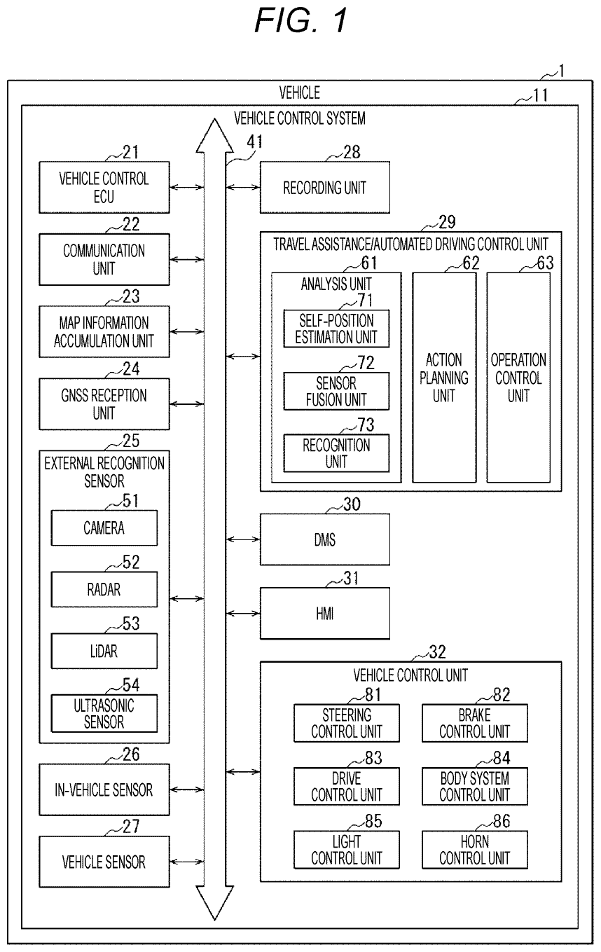

FIG. 1 is a block diagram illustrating a configuration example of a vehicle control system 11 that is an example of a mobile apparatus control system to which the present technology can be applied.

The vehicle control system 11 is provided in a vehicle 1 and performs processing related to travel assistance and automated driving of the vehicle 1.

The vehicle control system 11 includes a vehicle control electronic control unit (ECU) 21, a communication unit 22, a map information accumulation unit 23, a global navigation satellite system (GNSS) reception unit 24, an external recognition sensor 25, an in-vehicle sensor 26, a vehicle sensor 27, a recording unit 28, a travel assistance/automated driving control unit 29, a driver monitoring system (DMS) 30, a human machine interface (HMI) 31, and a vehicle control unit 32.

The vehicle control ECU 21, the communication unit 22, the map information accumulation unit 23, the GNSS reception unit 24, the external recognition sensor 25, the in-vehicle sensor 26, the vehicle sensor 27, the recording unit 28, the travel assistance/automated driving control unit 29, the driver monitoring system (DMS) 30, the human machine interface (HMI) 31, and the vehicle control unit 32 are communicably connected to each other via a communication network 41.

The communication network 41 is formed by, for example, an in-vehicle communication network, a bus, or the like that conforms to a digital bidirectional communication standard such as controller area network (CAN), local interconnect network (LIN), local area network (LAN), FlexRay (registered trademark), and Ethernet (registered trademark).

The communication network 41 may be selectively used depending on the type of data to be communicated, and for example, CAN is applied to data related to vehicle control, and Ethernet is applied to large-capacity data.

Note that each unit of the vehicle control system 11 may be directly connected not via the communication network 41 but by, for example, wireless communication that assumes communication at a relatively short distance, such as near field communication (NFC) or Bluetooth (registered trademark).

Note that, hereinafter, in a case where each unit of the vehicle control system 11 performs communication via the communication network 41, description of the communication network 41 is omitted. For example, in a case where the vehicle control ECU 21 and the communication unit 22 perform communication via the communication network 41, it is simply described that the processor 21 and the communication unit 22 perform communication.

The vehicle control ECU 21 includes, for example, various processors such as a central processing unit (CPU) and a micro processing unit (MPU). The vehicle control ECU 21 controls the entire or partial function of the vehicle control system 11.

The communication unit 22 communicates with various devices inside and outside the vehicle, other vehicles, servers, base stations, and the like, and transmits and receives various data. At this time, the communication unit 22 can perform communication using a plurality of communication schemes.

Communication with the outside of the vehicle executable by the communication unit 22 will be schematically described. The communication unit 22 communicates with a server (hereinafter, the server is referred to as an external server) or the like existing on an external network via a base station or an access point by, for example, a wireless communication method such as fifth generation mobile communication system (5G), long term evolution (LTE), dedicated short range communications (DSRC), or the like.

The external network with which the communication unit 22 performs communication is, for example, the Internet, a cloud network, a network unique to a company, or the like. The communication method by which the communication unit 22 communicates with the external network is not particularly limited as long as it is a wireless communication method capable of performing digital bidirectional communication at a communication speed equal to or more than a predetermined speed and at a distance equal to or longer than a predetermined distance.

Furthermore, for example, the communication unit 22 can communicate with a terminal existing in the vicinity of the host vehicle using a peer to peer (P2P) technology. The terminal present in the vicinity of the host vehicle is, for example, a terminal worn by a moving body moving at a relatively low speed such as a pedestrian or a bicycle, a terminal installed in a store or the like with a position fixed, or a machine type communication (MTC) terminal.

Moreover, the communication unit 22 can also perform V2X communication. The V2X communication refers to, for example, communication between the host vehicle and another vehicle, such as vehicle to vehicle communication with another vehicle, vehicle to infrastructure communication with a roadside device or the like, vehicle to home communication, and vehicle to pedestrian communication with a terminal or the like possessed by a pedestrian.

For example, the communication unit 22 can receive a program for updating software for controlling the operation of the vehicle control system 11 from the outside (Over The Air). The communication unit 22 can further receive map information, traffic information, information around the vehicle 1, and the like from the outside.

Furthermore, for example, the communication unit 22 can transmit information regarding the vehicle 1, information around the vehicle 1, and the like to the outside. Examples of the information regarding the vehicle 1 transmitted to the outside by the communication unit 22 include data indicating the state of the vehicle 1, a recognition result by the recognition unit 73, and the like. Moreover, for example, the communication unit 22 performs communication corresponding to a vehicle emergency call system such as an eCall.

Communication with the inside of the vehicle executable by the communication unit 22 will be schematically described. The communication unit 22 can communicate with each device in the vehicle using, for example, wireless communication. The communication unit 22 can perform wireless communication with a device in the vehicle by, for example, a communication method capable of performing digital bidirectional communication at a communication speed equal to or more than a predetermined speed or higher by wireless communication, such as wireless LAN, Bluetooth, NFC, or wireless USB (WUSB).

It is not limited thereto, and the communication unit 22 can also communicate with each device in the vehicle using wired communication. For example, the communication unit 22 can communicate with each device in the vehicle by wired communication via a cable connected to a connection terminal which is not illustrated. The communication unit 22 can communicate with each device in the vehicle by, for example, a communication method that enables digital bidirectional communication at a communication speed equal to or more than a predetermined speed by wired communication, such as universal serial bus (USB), high-definition multimedia interface (HDMI) (registered trademark), or mobile high-definition link (MHL).

Here, the device in the vehicle refers to, for example, a device that is not connected to the communication network 41 in the vehicle. As the device in the vehicle, for example, a mobile device or a wearable device carried by an occupant such as a driver or the like, an information device brought into the vehicle and temporarily installed, or the like is assumed.

For example, the communication unit 22 receives an electromagnetic wave transmitted by a road traffic information communication system (vehicle information and communication system (VICS) (registered trademark)), such as a radio wave beacon, an optical beacon, or FM multiplex broadcasting.

The map information accumulation unit 23 accumulates one or both of a map acquired from the outside and a map created by the vehicle 1. For example, the map information accumulation unit 23 accumulates a three-dimensional high-precision map, a global map having lower accuracy than the high-precision map and covering a wide area, and the like.

The high-precision map is, for example, a dynamic map, a point cloud map, a vector map, or the like. The dynamic map is, for example, a map including four layers of dynamic information, semi-dynamic information, semi-static information, and static information, and is provided to the vehicle 1 from an external server or the like.

The point cloud map is a map including point clouds (point cloud data). Here, the vector map indicates a map adapted to an advanced driver assistance system (ADAS) in which traffic information such as a lane and a signal position is associated with a point cloud map.

The point cloud map and the vector map may be provided from, for example, an external server or the like, or may be created by the vehicle 1 as a map for performing matching with a local map to be described later on the basis of a sensing result by a radar 52, a LiDAR 53, or the like, and may be accumulated in the map information accumulation unit 23. Furthermore, in a case where a high-precision map is provided from an external server or the like, for example, map data of several hundred meters square regarding a planned route on which the vehicle 1 travels from now is acquired from the external server or the like in order to reduce the communication capacity.

The position information acquisition unit 24 receives a global navigation satellite system (GNSS) signal from a GNSS satellite, and acquires position information of the vehicle 1. The received GNSS signal is supplied to the travel assistance/automated driving control unit 29. Note that the position information acquisition unit 24 is not limited to the method using the GNSS signal, and may acquire the position information using, for example, a beacon.

The external recognition sensor 25 includes various sensors used for recognizing an external situation of the vehicle 1, and supplies sensor data from each sensor to each part of the vehicle control system 11. Any type and number of sensors included in the external recognition sensor 25 may be adopted.

For example, the external recognition sensor 25 includes a camera 51, a radar 52, a light detection and ranging or laser imaging detection and ranging (LiDAR) 53, and an ultrasonic sensor 54. It is not limited thereto, and the external recognition sensor 25 may include one or more types of sensors among the camera 51, the radar 52, the LiDAR 53, and the ultrasonic sensor 54.

The numbers of the cameras 51, the radars 52, the LiDAR 53, and the ultrasonic sensors 54 are not particularly limited as long as they can be practically installed in the vehicle 1. Furthermore, the type of sensor included in the external recognition sensor 25 is not limited to this example, and the external recognition sensor 25 may include another type of sensor. An example of the sensing area of each sensor included in the external recognition sensor 25 will be described later.

Note that the imaging method of the camera 51 is not particularly limited as long as it is an imaging method capable of distance measurement. For example, as the camera 51, cameras of various imaging methods such as a time of flight (ToF) camera, a stereo camera, a monocular camera, and an infrared camera can be applied as necessary. It is not limited thereto, and the camera 51 may simply acquire a captured image regardless of distance measurement.

In addition, for example, the external recognition sensor 25 can include an environment sensor for detecting the environment for the vehicle 1. The environment sensor is a sensor for detecting an environment such as weather, climate, and brightness, and can include various sensors such as a raindrop sensor, a fog sensor, a sunshine sensor, a snow sensor, and an illuminance sensor, for example.

Moreover, for example, the external recognition sensor 25 includes a microphone used for detecting a sound around the vehicle 1, a position of a sound source, and the like.

The in-vehicle sensor 26 includes various sensors for detection of information inside the vehicle, and supplies sensor data from each sensor to each unit of the vehicle control system 11. The types and the number of various sensors included in the in-vehicle sensor 26 are not particularly limited as long as they can be practically installed in the vehicle 1.

For example, the in-vehicle sensor 26 can include one or more sensors of a camera, a radar, a seating sensor, a steering wheel sensor, a microphone, and a biological sensor. As the camera included in the in-vehicle sensor 26, for example, cameras of various imaging methods capable of measuring a distance, such as a ToF camera, a stereo camera, a monocular camera, and an infrared camera, can be used. It is not limited thereto, and the camera included in the in-vehicle sensor 26 may simply acquire a captured image regardless of distance measurement. The biological sensor included in the in-vehicle sensor 26 is provided in, for example, a seat, a steering wheel, or the like, and detects various types of biological information of the occupant such as the driver.

The vehicle sensor 27 includes various sensors for detecting the state of the vehicle 1, and supplies sensor data from each sensor to each part of the vehicle control system 11. The types and the number of various sensors included in the vehicle sensor 27 are not particularly limited as long as they can be practically installed in the vehicle 1.

For example, the vehicle sensor 27 includes a speed sensor, an acceleration sensor, an angular velocity sensor (gyro sensor), and an inertial measurement unit (IMU) integrating these sensors. For example, the vehicle sensor 27 includes a steering angle sensor that detects a steering angle of a steering wheel, a yaw rate sensor, an accelerator sensor that detects an operation amount of an accelerator pedal, and a brake sensor that detects an operation amount of a brake pedal.

For example, the vehicle sensor 27 includes a rotation sensor that detects the number of rotations of the engine or the motor, an air pressure sensor that detects the air pressure of the tire, a slip rate sensor that detects the slip rate of the tire, and a wheel speed sensor that detects the rotation speed of the wheel. For example, the vehicle sensor 27 includes a battery sensor that detects the remaining amount and temperature of the battery, and an impact sensor that detects an external impact.

The recording unit 28 includes at least one of a non-volatile storage medium or a volatile storage medium, and stores data and a program. The recording unit 28 is used as, for example, an electrically erasable programmable read only memory (EEPROM) and a random access memory (RAM), and a magnetic storage device such as a hard disc drive (HDD), a semiconductor storage device, an optical storage device, and a magneto-optical storage device can be applied as the storage medium.

The recording unit 28 records various programs and data used by each unit of the vehicle control system 11. For example, the recording unit 28 includes an Event Data Recorder (EDR) and a Data Storage System for Automated Driving (DSSAD), and records information of the vehicle 1 before and after an event such as an accident and biological information acquired by the in-vehicle sensor 26.

The travel assistance/automated driving control unit 29 controls travel assistance and automated driving of the vehicle 1. For example, the travel assistance/automated driving control unit 29 includes an analysis unit 61, an action planning unit 62, and an operation control unit 63.

The analysis unit 61 analyzes the vehicle 1 and a situation of the surroundings. The analysis unit 61 includes a self-position estimation unit 71, a sensor fusion unit 72, and the recognition unit 73.

The self-position estimation unit 71 estimates a self-position of the vehicle 1 on the basis of sensor data from the external recognition sensor 25 and a high-precision map accumulated in the map information accumulation unit 23. For example, the self-position estimation unit 71 creates a local map on the basis of sensor data from the external recognition sensor 25, and estimates the self-position of the vehicle 1 by matching the local map with the high-precision map. The position of the vehicle 1 is based on, for example, the center of a rear wheel-to-axle.

The local map is, for example, a three-dimensional high-precision map created using a technology such as simultaneous localization and mapping (SLAM), or the like, an occupancy grid map, or the like.

The three-dimensional high-precision map is, for example, the above-described point cloud map or the like. The occupancy grid map is a map in which a three-dimensional or two-dimensional space around the vehicle 1 is divided into grids (lattices) of a predetermined size, and an occupancy state of an object is indicated in units of grids. The occupancy state of the object is indicated by, for example, the presence or absence or existence probability of the object. The local map is also used for detection processing and recognition processing of a situation outside the vehicle 1 by the recognition unit 73, for example.

Note that the self-position estimation unit 71 may estimate the self-position of the vehicle 1 on the basis of the GNSS signal and sensor data from the vehicle sensor 27.

The sensor fusion unit 72 performs sensor fusion processing to obtain new information by combining a plurality of different types of sensor data (for example, image data supplied from the camera 51 and sensor data supplied from the radar 52). Methods for combining different types of sensor data include integration, fusion, association, and the like.

The recognition unit 73 executes detection processing for detecting a situation outside the vehicle 1 and recognition processing for recognizing a situation outside the vehicle 1.

For example, the recognition unit 73 performs detection processing and recognition processing of the external situation of the vehicle 1 on the basis of information from the external recognition sensor 25, information from the self-position estimation unit 71, information from the sensor fusion unit 72, and the like.

Specifically, for example, the recognition unit 73 performs detection processing, recognition processing, and the like of an object around the vehicle 1. The object detection processing is, for example, processing of detecting the presence or absence, size, shape, position, movement, and the like of an object. The object recognition processing is, for example, processing of recognizing an attribute such as a type of an object or the like or identifying a specific object. However, the detection processing and the recognition processing are not always clearly separated and may overlap.

For example, the recognition unit 73 detects an object around the vehicle 1 by performing clustering to classify a point cloud based on sensor data by the LiDAR 53, the radar 52, or the like for each cluster of the point cloud. Thus, the presence or absence, size, shape, and position of the object around the vehicle 1 are detected.

For example, the recognition unit 73 detects a motion of the object around the vehicle 1 by performing tracking that follows a motion of the cluster of point clouds classified by clustering. Thus, the speed and the traveling direction (movement vector) of the object around the vehicle 1 are detected.

For example, the recognition unit 73 detects or recognizes a vehicle, a person, a bicycle, an obstacle, a structure, a road, a traffic light, a traffic sign, a road sign, and the like with respect to the image data supplied from the camera 51. In addition, the type of the object around the vehicle 1 may be recognized by performing recognition processing such as semantic segmentation.

For example, the recognition unit 73 can perform recognition processing of traffic rules around the vehicle 1 on the basis of a map accumulated in the map information accumulation unit 23, an estimation result of the self-position by the self-position estimation unit 71, and a recognition result of an object around the vehicle 1 by the recognition unit 73. Through this process, the recognition unit 73 can recognize the position and state of a signal, the contents of traffic signs and road signs, the contents of traffic regulations, travelable lanes, and the like.

For example, the recognition unit 73 can perform recognition processing of the environment around the vehicle 1. As the surrounding environment to be recognized by the recognition unit 73, weather, temperature, humidity, brightness, road surface conditions, and the like are assumed.

The action planning unit 62 creates an action plan for the vehicle 1. For example, the action planning unit 62 creates an action plan by performing processing of route planning and route following.

Note that the route planning (global path planning) is a process of planning a rough route from a start to a goal. This route planning is called track planning, and also includes processing of track generation (local path planning) that allows safe and smooth traveling near the vehicle 1 in consideration of motion characteristics of the vehicle 1 in the route planned by the route planning. The route planning may be distinguished from long-term route planning, and startup generation from short-term route planning or local route planning. The safety-first route represents a concept similar to startup generation, short-term route planning, or local route planning.

The route following is a process of planning operation for safely and accurately traveling on the route planned by the route planning within a planned time. For example, the action planning unit 62 can calculate the target speed and the target angular velocity of the vehicle 1 on the basis of the result of the path following processing.

The operation control unit 63 controls operation of the vehicle 1 in order to achieve the action plan created by the action planning unit 62.

For example, the operation control unit 63 controls a steering control unit 81, a brake control unit 82, and a drive control unit 83 included in the vehicle control unit 32 to be described later, and performs acceleration and deceleration control and direction control so that the vehicle 1 travels on the track calculated by the track planning. For example, the operation control unit 63 performs cooperative control for the purpose of implementing the functions of the ADAS such as collision avoidance or impact mitigation, follow-up traveling, vehicle speed maintaining traveling, collision warning of the host vehicle, lane deviation warning of the host vehicle, and the like. For example, the operation control unit 63 performs cooperative control for the purpose of automated driving or the like in which the vehicle automatedly travels without depending on the operation of the driver.

The DMS 30 performs authentication processing of a driver, recognition processing of a state of the driver, and the like on the basis of sensor data from the in-vehicle sensor 26, input data input to the HMI 31 to be described later, and the like. In this case, as the state of the driver to be recognized by the DMS 30, for example, physical condition, alertness, concentration, fatigue, line-of-sight direction, degree of drunkenness, driving operation, posture, and the like are assumed.

Note that the DMS 30 may perform authentication processing of an occupant other than the driver and recognition processing of a state of the occupant. Furthermore, for example, the DMS 30 may perform recognition processing of the situation inside the vehicle on the basis of sensor data from the in-vehicle sensor 26. As the condition inside the vehicle to be recognized, for example, temperature, humidity, brightness, odor, and the like are assumed.

The HMI 31 receives inputs of various data, instructions, and the like, and presents various data to a driver or the like.

Input of data through the HMI 31 will be schematically described. The HMI 31 includes an input device for a person to input data. The HMI 31 generates an input signal on the basis of data, an instruction, or the like input with an input device, and supplies the input signal to each unit of the vehicle control system 11.

The HMI 31 includes, for example, an operator such as a touch panel, a button, a switch, and a lever as the input device. It is not limited thereto, and the HMI 31 may further include an input device that enables input of information by a method other than manual operation by voice, gesture, or the like. Moreover, the HMI 31 may use, for example, a remote control device using infrared rays or radio waves, or an external connection device such as a mobile device or a wearable device corresponding to the operation of the vehicle control system 11 as an input device.

Presentation of data by the HMI 31 will be schematically described. The HMI 31 generates visual information, auditory information, and tactile information for the passenger or the outside of the vehicle. Furthermore, the HMI 31 performs output control for controlling the output, output content, output timing, output method, and the like of each piece of generated information.

The HMI 31 generates and outputs, for example, an operation screen, a state display of the vehicle 1, a warning display, an image such as a monitor image indicating a situation around the vehicle 1, and information indicated by light as the visual information. Furthermore, the HMI 31 generates and outputs information indicated by sounds such as voice guidance, a warning sound, and a warning message, for example, as the auditory information. Moreover, the HMI 31 generates and outputs, as the tactile information, information given to the tactile sense of the passenger by, for example, force, vibration, motion, or the like.

As an output device that the HMI 31 outputs visual information, for example, a display device that presents visual information by displaying an image by itself or a projector device that presents visual information by projecting an image can be applied.

Note that the display device may be, for example, a device that displays visual information in the field of view of the passenger, such as a head-up display, a transmissive display, or a wearable device having an augmented reality (AR) function, in addition to a display device having a normal display.

In addition, the HMI 31, a display device included in a navigation device, an instrument panel, a camera monitoring system (CMS), an electronic mirror, a lamp, or the like provided in the vehicle 1 can also be used as an output device that outputs visual information.

As the output device from which the HMI 31 outputs the auditory information, for example, an audio speaker, a headphone, or an earphone can be applied.

As an output device to which the HMI 31 outputs tactile information, for example, a haptic element using a haptic technology can be applied. The haptics element is provided, for example, at a portion with which a passenger of the vehicle 1 comes into contact, such as a steering wheel or a seat.

The vehicle control unit 32 controls each unit of the vehicle 1. The vehicle control unit 32 includes the steering control unit 81, the brake control unit 82, the drive control unit 83, a body system control unit 84, a light control unit 85, and a horn control unit 86.

The steering control unit 81 performs detection, control, and the like of a state of a steering system of the vehicle 1. The steering system includes, for example, a steering mechanism including a steering wheel and the like, an electric power steering, and the like. The steering control unit 81 includes, for example, a control unit such as an ECU and the like that controls the steering system, an actuator that drives the steering system, and the like.

The brake control unit 82 performs detection, control, and the like of a state of a brake system of the vehicle 1. The brake system includes, for example, a brake mechanism including a brake pedal, an antilock brake system (ABS), a regenerative brake mechanism, and the like. The brake control unit 82 includes, for example, a control unit such as an ECU that controls a brake system.

The drive control unit 83 performs detection, control, and the like of a state of a drive system of the vehicle 1. The drive system includes, for example, a driving force generation device for generating a driving force such as an accelerator pedal, an internal combustion engine, a driving motor, or the like, a driving force transmission mechanism for transmitting the driving force to wheels, and the like. The drive control unit 83 includes, for example, a control unit such as an ECU that controls the drive system.

The body system control unit 84 performs detection and control of a state of a body system of the vehicle 1, and the like. The body system includes, for example, a keyless entry system, a smart key system, a power window device, a power seat, an air conditioner, an airbag, a seat belt, a shift lever, and the like. The body system control unit 84 includes, for example, a control unit such as an ECU that controls the body system.

The light control unit 85 performs detection and control of states of various lights of the vehicle 1, and the like. As the lights to be controlled, for example, headlights, backlights, fog lights, turn signals, brake lights, projections, bumper displays, and the like are assumed. The light control unit 85 includes a control unit such as an ECU that performs light control.

The horn control unit 86 performs detection and control of a state of a car horn of the vehicle 1, and the like. The horn control unit 86 includes, for example, a control unit such as an ECU that controls the car horn.

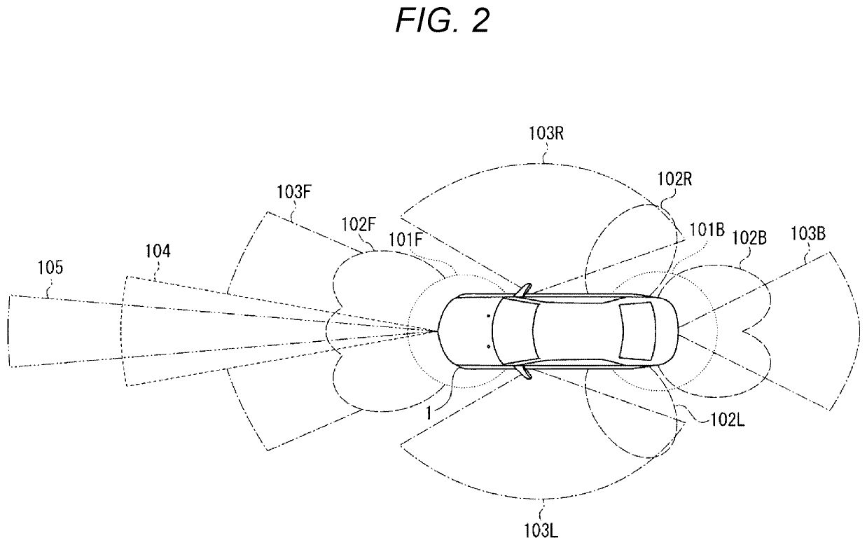

FIG. 2 is a diagram illustrating an example of a sensing area by the camera 51, the radar 52, the LiDAR 53, the ultrasonic sensor 54, and the like of the external recognition sensor 25 in FIG. 1. Note that FIG. 2 schematically illustrates the vehicle 1 as viewed from above, where the left end side is the front end (front) side of the vehicle 1 and the right end side is the rear end (rear) side of the vehicle 1.

A sensing area 101F and a sensing area 101B illustrate examples of sensing areas by the ultrasonic sensor 54. The sensing area 101F covers the periphery of the front end of the vehicle 1 by a plurality of ultrasonic sensors 54. The sensing area 101B covers the periphery of the rear end of the vehicle 1 by a plurality of ultrasonic sensors 54.

Sensing results in the sensing area 101F and the sensing area 101B are used, for example, for parking assistance and the like of the vehicle 1.

Sensing areas 102F to 102B illustrate examples of sensing areas of the radar 52 for a short distance or a middle distance. The sensing area 102F covers a position farther than the sensing area 101F in front of the vehicle 1. The sensing area 102B covers a position farther than the sensing area 101B behind the vehicle 1. A sensing area 102L covers the rear periphery of the left side surface of the vehicle 1. A sensing area 102R covers the rear periphery of the right side surface of the vehicle 1.

The sensing result in the sensing area 102F is used, for example, to detect a vehicle, a pedestrian, or the like present in front of the vehicle 1. A sensing result in the sensing area 102B is used, for example, for a collision prevention function or the like behind the vehicle 1. Sensing results in the sensing areas 102L and 102R are used, for example, for detection of an object in a blind spot on a side of the vehicle 1, and the like.

Sensing areas 103F to 103B illustrate examples of sensing areas by the camera 51. The sensing area 103F covers a position farther than the sensing area 102F in front of the vehicle 1. The sensing area 103B covers a position farther than the sensing area 102B behind the vehicle 1. A sensing area 103L covers the periphery of the left side surface of the vehicle 1. A sensing area 103R covers the periphery of the right side surface of the vehicle 1.

The sensing result in the sensing area 103F can be used for, for example, recognition of a traffic light or a traffic sign, a lane departure prevention assist system, and an automatic headlight control system. The sensing result in the sensing area 103B can be used for, for example, parking assistance and a surround view system. The sensing results in the sensing area 103L and the sensing area 103R can be used for a surround view system, for example.

A sensing area 104 illustrates an example of a sensing area by the LiDAR 53. The sensing area 104 covers a position farther than the sensing area 103F in front of the vehicle 1. Meanwhile, the sensing area 104 has a narrower range in a left-right direction than the sensing area 103F.

The sensing result in the sensing area 104 is used, for example, for detecting an object such as a surrounding vehicle.

A sensing area 105 illustrates an example of a sensing area of the long-range radar 52.

The sensing area 105 covers a position farther than the sensing area 104 in front of the vehicle 1. Meanwhile, the sensing area 105 has a narrower range in the left-right direction than the sensing area 104.

The sensing result in the sensing area 105 is used for, for example, adaptive cruise control (ACC), emergency braking, collision avoidance, and the like.

Note that the sensing areas of the respective sensors of the camera 51, the radar 52, the LiDAR 53, and the ultrasonic sensors 54 included in the external recognition sensor 25 may have various configurations other than those in FIG. 2. Specifically, the ultrasonic sensors 54 may also sense the side of the vehicle 1, or the LiDAR 53 may sense the rear of the vehicle 1. Furthermore, the installation position of each sensor is not limited to each example described above. In addition, the number of each of the sensors may be one or more.

### 2. Embodiment

Embodiments of the present technology will be described. Note that this embodiment is a technology mainly related to a self-position estimation system in the vehicle control system 11 of FIG. 1.

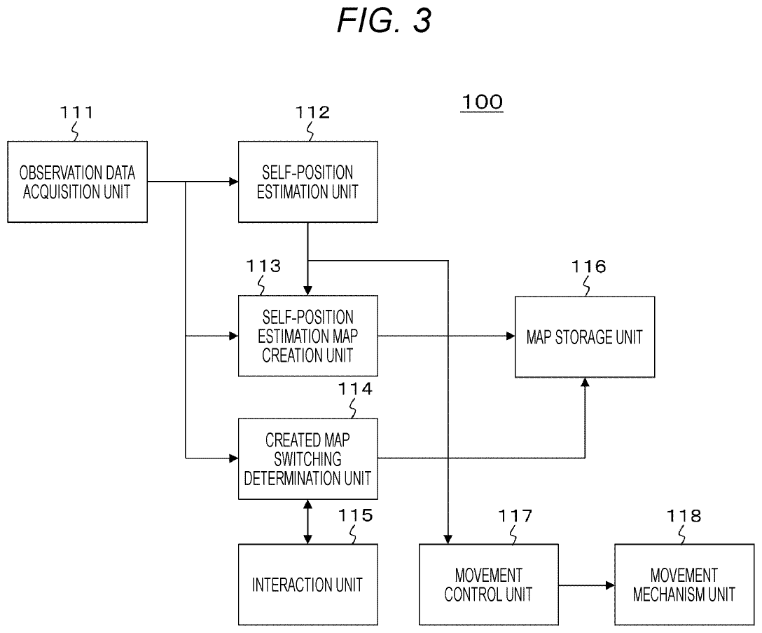

FIG. 3 illustrates a configuration example of a map creation processing unit 100 in the self-position estimation system of a mobile apparatus as an autonomous mobile body such as a robot or a car, for example. The map creation processing unit 100 creates a self-position estimation map and stores the map in a storage.

The map creation processing unit 100 includes an observation data acquisition unit 111, a self-position estimation unit 112, a self-position estimation map creation unit 113, a created map switching determination unit 114, an interaction unit 115, a map storage unit 116, a movement control unit 117, and a movement mechanism unit 118.

The observation data acquisition unit 111 includes various sensors (hereinafter, appropriately referred to as a “sensor group”) for recognizing the surrounding environment. The sensor group includes, for example, a sensor for obtaining a surrounding environment recognition result for map creation, and a sensor for obtaining a surrounding environment recognition result for map switching determination. The sensor group includes, for example, a camera, a LiDAR, an IMU, a wheel odometry, a vibration sensor, an inclination sensor, a GNSS receiver, and the like.

The self-position estimation unit 112 estimates the position and attitude of the mobile apparatus on the basis of observation data (surrounding environment recognition result) obtained by the observation data acquisition unit 111. The self-position estimation map creation unit 113 creates a self-position estimation map, for example, a key frame map, on the basis of the position and attitude of the mobile apparatus estimated by the self-position estimation unit 112 and the observation data (surrounding environment recognition result) obtained by the observation data acquisition unit 111.

The key frame map includes a plurality of registered images (hereinafter, appropriately referred to as a “key frame”) created on the basis of a plurality of captured images captured at positions and attitudes different from those of the mobile apparatus, and metadata of each key frame.

The map storage unit 116 stores the self-position estimation map created by the self-position estimation map creation unit 113. The created map switching determination unit 114 determines whether or not it is a map switching timing on the basis of the observation data (surrounding environment recognition result) obtained by the observation data acquisition unit 111, a creation status of the map in the self-position estimation map creation unit 113, a user operation, and the like.

The self-position estimation map created by the self-position estimation map creation unit 113 is stored as a new map in the map storage unit 116 every time the created map switching determination unit 114 determines that it is the map switching timing. Thus, the self-position estimation map creation unit 113 sequentially creates maps of adjacent regions.

The interaction unit 115 includes a graphic user interface (GUI), a button, a controller, and the like. The user can input user operation information used in the created map switching determination unit 114, for example, with the interaction unit 115.

The movement control unit 117 controls the movement mechanism unit 118 on the basis of, for example, the position and attitude of the mobile apparatus estimated by the self-position estimation unit 112, and causes the mobile apparatus to move for map creation. Here, the movement mechanism unit 118 includes, for example, a motor or the like. Note that, in addition to a case where the movement of the mobile apparatus for map creation is automatically performed under the control of the movement control unit 117 on the basis of the position and attitude of the mobile apparatus estimated by the self-position estimation unit 112 in this manner, it is also conceivable that the movement of the mobile apparatus for map creation is performed by a movement operation by the user.

The created map switching determination unit 114 will be further described. As described above, the created map switching determination unit 114 determines the map switching timing on the basis of, for example, the observation data (surrounding environment recognition result) obtained by the observation data acquisition unit 111.

For example, when a change amount ΔLight_color of a current light color tone included in the recognition result of the surrounding environment is larger than a threshold diff_threshold_light_color of a change amount of a light color tone, the created map switching determination unit 114 determines that it is the map switching timing.

Furthermore, for example, when a change amount Δdistance of a current distance to a surrounding object is larger than a threshold diff_threshold_distance of a change amount of the distance to the surrounding object, the created map switching determination unit 114 determines that it is the map switching timing.

Furthermore, for example, when a change amount Δvibration of current vibration is larger than a threshold diff_threshold_vibration of a change amount of vibration, the created map switching determination unit 114 determines that it is the map switching timing. Here, as the change amount of vibration, the magnitude of vibration and a change amount of frequency can be considered.

Furthermore, for example, when a change amount Δgradient of current inclination is larger than a threshold diff_threshold_gradient of a change amount of inclination, the created map switching determination unit 114 determines that it is the map switching timing.

Note that, in addition to the above, the created map switching determination unit 114 may determine that it is the map switching timing on the basis of a change amount of the current brightness of light, a change amount of the current number of moving objects, opening and closing of the door, a stop of the mobile apparatus, and the like.

In this manner, by determining the map switching timing on the basis of the observation data (surrounding environment recognition result), the map used by the mobile apparatus is divided on the basis of the surrounding environment, so that management and update can be satisfactorily performed. In this case, each map created by the self-position estimation map creation unit 113 and stored in the map storage unit 116 is a map whose range is a region having similar environmental information.

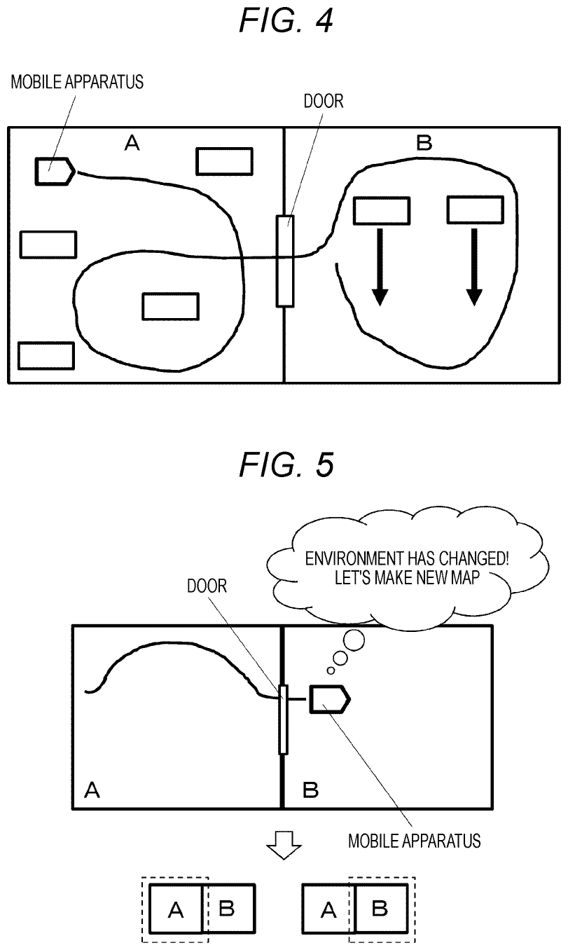

FIG. 4 illustrates an example of a case where the self-position estimation map is created in an implementation environment in which one room A and one room B having different surrounding environments are connected by a door. Here, it is assumed that room A is a fixed room without a layout change, and room B is a room in which a layout change is frequently performed.

In this case, it is assumed that the mobile apparatus continuously moves in (scans) rooms A and B to create the self-position estimation maps of rooms A and B together. At that time, in a case where the layout of room B is changed, it is necessary to update the map of room B. Note that an arrow in room B indicates a layout change.

However, the self-position estimation maps of rooms A and B are created together, and it is difficult to update only room B. Accordingly, it is conceivable that the mobile apparatus moves in (scans) only in room B again to create a self-position estimation map of only room B. In that case, there are a self-position estimation map in which rooms A and B are combined and a self-position estimation map in which only room B is present, and the map has overlapping regions, which makes management difficult and causes a problem of wasteful storage capacity consumption.

In the present technology, as illustrated in FIG. 5, in a case where the mobile apparatus moves from room A to room B, the created map switching determination unit 114 recognizes that the environment has changed by opening and closing the door, for example, and switches the map. That is, as the mobile apparatus moves in (scans) room A, a self-position estimation map of only room A is created as indicated by a broken line frame in the lower left part of FIG. 5. Then, as the mobile apparatus enters room B and moves in (scans) the room, a self-position estimation map of only room B is created as indicated by a broken line frame in the lower right of FIG. 5.

With this configuration, for example, in a case where the layout of room B is changed, the mobile apparatus moves in (scans) only room B again, and the self-position estimation map of only room B can be updated. In this case, a problem that management becomes difficult and a storage capacity is wastefully consumed due to a partially overlapped map as described with reference to FIG. 4 is avoided.

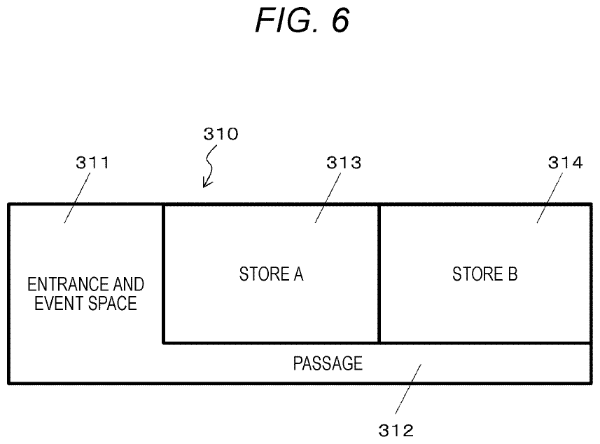

Next, an application example in a representative implementation environment will be described. FIG. 6 illustrates a case where the implementation environment is a shopping mall 310. In this shopping mall 310, there are a shared entrance and event space 311, an in-floor passage 312, an in-floor store (store A) 313, and an in-floor store (store B) 314.

Here, the shared entrance and event space 311 is wide but has many layout changes. Furthermore, the passage 312 has no layout change but is narrower than the shared entrance and event space 311. The stores 313 and 314 have a larger space (width) than the passage 312, the layout is changed for each store, and the color tone of light and decorated object are different for each store.

In the implementation environment of the shopping mall 310, a case will be considered where the mobile apparatus moves in (scans) the shared entrance and event space 311, the passage 312, the store 313, and the store 314 in this order to create the self-position estimation map.

In this case, when the mobile apparatus enters the passage 312 after moving in (scanning) the shared entrance and event space 311, for example, the change amount of the current distance to the surrounding object becomes larger than the threshold due to a difference in space (width), and the self-position estimation map to be created is switched from the map of the shared entrance and event space 311 to the map of the passage 312.

Furthermore, next, when the mobile apparatus enters the store 313 after moving in (scanning) the passage 312, for example, the change amount of the current light color tone becomes larger than the threshold and the change amount of the current distance to the surrounding object becomes larger than the threshold due to the difference in color tone of ambient light and the difference in size of the space (width), and the self-position estimation map to be created is switched from the map of the passage 312 to the map of the store (store A) 313.

Furthermore, next, when the mobile apparatus enters the store 313 after moving in (scanning) the store 314, for example, the change amount of the current light color tone becomes larger than the threshold due to the difference in color tone of the ambient light, and the map of the self-position estimation map to be created is switched from the map of the store (store A) 313 to the map of the store (store B) 314.

As described above, in the implementation environment of the shopping mall 310, the self-position estimation maps of the shared entrance and event space 311, the passage 312, the store (store A) 313, and the store (store B) 314 are separately created. Thus, regarding the shared entrance and event space 311, the store (store A) 313, and the store (store B) 314 in which there are many layout changes, the mobile apparatus moves in (scans) only the region thereof, and the self-position estimation map can be easily changed. Therefore, since there is no map having overlapping regions, management is facilitated, and the storage capacity is not wastefully consumed.

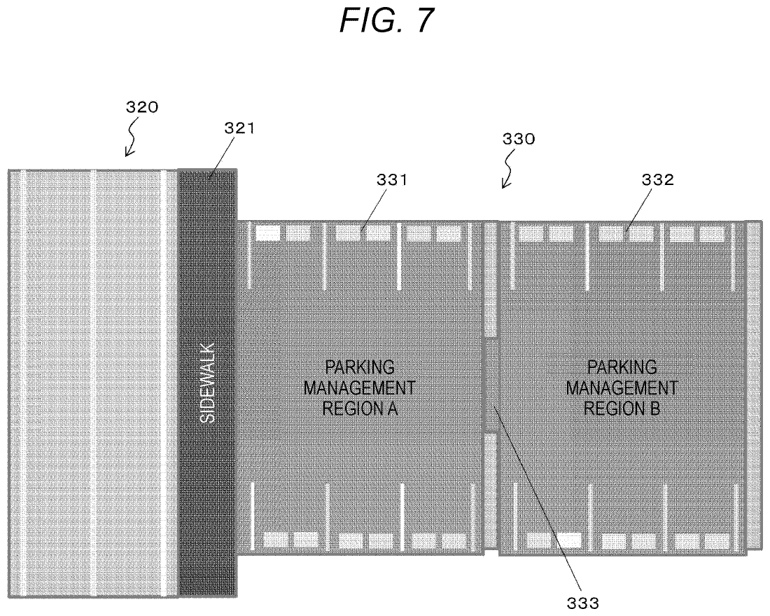

FIG. 7 illustrates a case where the implementation environment is a road 320 and a parking space 330 adjacent thereto. There is a sidewalk 321 at the end of the road 320. That is, the sidewalk 321 exists between the road 320 and the parking space 330. Furthermore, in the parking space 330, there is a plurality of parking management regions, in this example, a parking management region (parking management region A) 331 and a parking management region (parking management region B) 332.

Here, in a case of entering the parking space 330 from the road 320, the mobile apparatus enters the parking space 330 from the main body of the road 320 across the sidewalk 321. In this case, there is a step on the sidewalk 321, and vibration due to the step is generated when the user crosses the sidewalk. In addition, the colors of the ground of the sidewalk 321 and the parking space 330 are different. In addition, a narrow space (width) portion 333 exists between the parking management region 331 and the parking management region 332.

In the implementation environment of the road 320 and the parking space 330, a case will be considered where the mobile apparatus moves on (scans) the road 320, the parking management region 331 of the parking space 330, and the parking management region 332 of the parking space 330 in this order to create the self-position estimation map.

In this case, when the mobile apparatus moves on (scans) the road 320 and then enters the parking management region 331 of the parking space 330 across the sidewalk 321, for example, due to generation of vibration at the time of crossing the sidewalk 321 and a difference in color between the sidewalk 321 and the parking management region 331, the change amount of the current vibration amount becomes larger than the threshold and the change amount of the current light color tone becomes larger than the threshold, and the self-position estimation map is switched from the map of the road 320 to the map of the parking management region 331.

Furthermore, next, when the mobile apparatus enters the parking management region 332 after moving on (scanning) the parking management region 331, for example, the mobile apparatus passes through the narrow space (width) portion. Thus, the change amount of the current distance to the surrounding object becomes larger than the threshold, and the self-position estimation map to be created is switched from the map of the parking management region (parking management region A) 331 to the map of the parking management region (parking management region B) 332.

As described above, in the implementation environment of the road 320 and the parking space 330, the self-position estimation maps of the road 320, the parking management region 331 of the parking space 330, and the parking management region 332 of the parking space 330 are separately created. Thus, in a case where the layout is changed in the parking management region 331 or the parking management region 332, the mobile apparatus moves in (scans) only the region thereof, and the self-position estimation map can be easily changed. Therefore, since there is no map having overlapping regions, management is facilitated, and the storage capacity is not wastefully consumed.

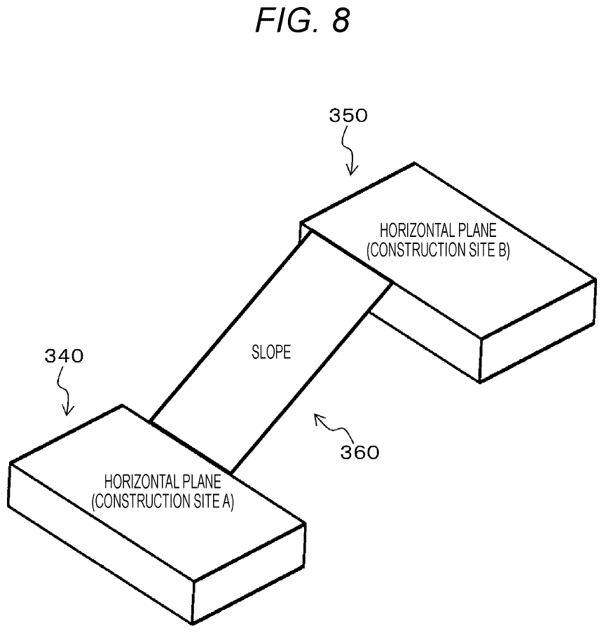

FIG. 8 illustrates a case where the implementation environment is a construction site (construction site A) 340, a construction site (construction site B) 350, and a slope 360 connecting them. Here, the construction site 340 and the construction site 350 are on a horizontal plane. Furthermore, in the slope 360 and the construction sites 340 and 350, the colors of the ground are different, and the vibration during the movement is also different depending on the structure of the ground. For example, the vibration amount at the time of movement of the construction sites 340 and 350 having a gravel structure is larger than that of the slope 360 having an asphalt structure.

In the implementation environment of the construction sites 340 and 350 and the slope 360, a case will be considered where the mobile apparatus moves on (scans) the construction site 340, the slope 360, and the construction site 350 in this order to create the self-position estimation map.

In this case, when the mobile apparatus enters the slope 360 after moving on (scanning) the construction site 340, for example, due to a difference in inclination, a difference in vibration generated at the time of movement, and a difference in color of the ground between the construction site 340 and the slope 360, the change amount of the current inclination becomes larger than the threshold, the change amount of the current vibration amount becomes larger than the threshold, the change amount of the current light color tone becomes larger than the threshold, and the self-position estimation map to be created is switched from the map of the construction site (construction site A) 340 to the map of the slope 360.

Furthermore, next, when the mobile apparatus enters the construction site 350 after moving on (scanning) the slope 360, for example, due to a difference in inclination, a difference in vibration generated at the time of movement, and a difference in color of the ground between the slope 360 and the construction site 350, the change amount of the current inclination becomes larger than the threshold, the change amount of the current vibration amount becomes larger than the threshold, the change amount of the current light color tone becomes larger than the threshold, and the self-position estimation map to be created is switched from the map of the slope 360 to the map of the construction site (construction site B) 350.

In this manner, in the implementation environment of the construction sites 340 and 350 and the slope 360, the self-position estimation maps of the construction site 340, the slope 360, and the construction site 350 are separately created. Thus, with respect to the construction site (construction site A) 340 and the construction site (construction site A) 350 where there are many layout changes, the mobile apparatus moves in (scans) only the region thereof, and the self-position estimation map can be easily changed. Therefore, since there is no map having overlapping regions, management is facilitated, and the storage capacity is not wastefully consumed.

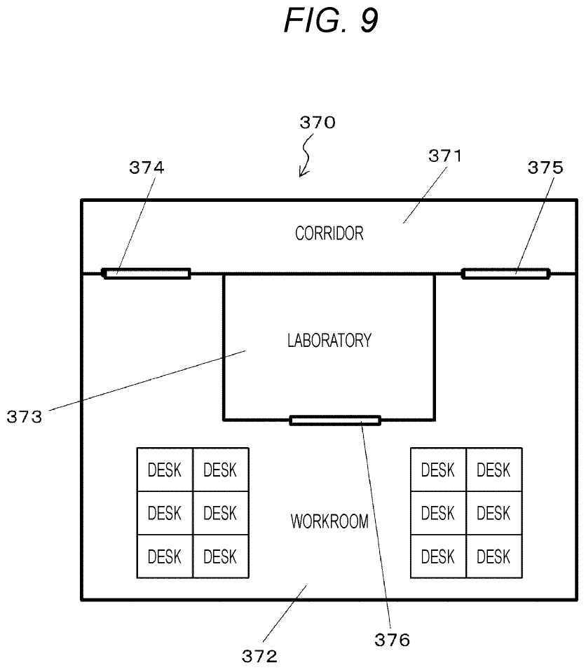

FIG. 9 illustrates a case where the implementation environment is an office 370. In this office 370, there are a corridor 371, a workroom 372, and a laboratory 373. Then, doors 374 and 375 are disposed between the corridor 371 and the workroom 372, and a door 376 is disposed between the workroom 372 and the laboratory 373.

Here, the corridor 371 is dark and narrow, and the workroom 372 is bright. In addition, the brightness of the laboratory 376 is the same as that of the workroom 372, but is narrow. Furthermore, in order to enter the workroom 372 from the corridor 371, the mobile apparatus needs to be stopped in order to open and close the door 374 or the door 375. In addition, in order to enter the laboratory 376 from the workroom 372, the mobile apparatus needs to be stopped in order to open and close the door 376.

In the implementation environment of the office 370, a case will be considered where the mobile apparatus moves in (scans) the corridor 371, the workroom 372, and the laboratory 373 in this order to create the self-position estimation map.

In this case, when the mobile apparatus enters the workroom 372 after moving in (scanning) the corridor 371, for example, due to a difference in space (width) and a difference in brightness, the change amount of the current distance to the surrounding object becomes larger than the threshold, and the change amount of the current light color tone becomes larger than the threshold, and the self-position estimation map to be created is switched from the map of the corridor 371 to the map of the workroom 372. Note that, in this case, also because the mobile apparatus stops to open and close the door 374 or the door 375 when entering the workroom 372 from the corridor 371, the self-position estimation map to be created can be switched from the map of the corridor 371 to the map of the workroom 372.

Next, when the mobile apparatus enters the laboratory 373 after moving in (scanning) the workroom 372, for example, the change amount of the current distance to the surrounding object becomes larger than the threshold due to the difference in space (width), and the self-position estimation map to be created is switched from the map of the workroom 372 to the map of the laboratory 373. Note that, in this case, also because the mobile apparatus stops to open and close the door 376 when entering the laboratory 373 from the workroom 372, the self-position estimation map to be created can be switched from the map of the workroom 372 to the map of the laboratory 373.

As described above, in the implementation environment of the office 370, the self-position estimation maps of the corridor 371, the workroom 372, and the laboratory 373 are separately created. Thus, for example, in a case where the layout is changed in the workroom 372 or the laboratory 373, the mobile apparatus moves in (scans) only the region thereof, and the self-position estimation map can be easily changed. Therefore, since there is no map having overlapping regions, management is facilitated, and the storage capacity is not wastefully consumed.

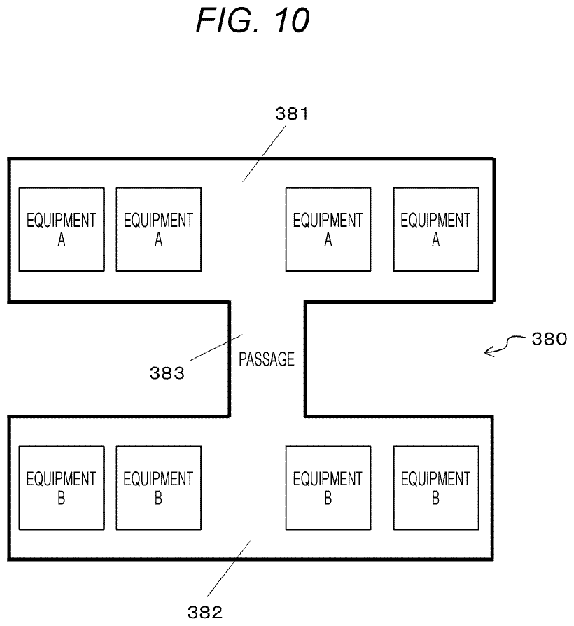

FIG. 10 illustrates a case where the implementation environment is a factory 380. In the factory 380, there are an equipment A region 381 in which equipment A is disposed, an equipment B region 382 in which equipment B is disposed, and a passage 383 connecting these two regions. Here, the passage 383 is dark and narrow, and the regions 381 and 382 is bright and wide.

In the implementation environment of the factory 380, a case will be considered where the mobile apparatus moves in (scans) the equipment A region 381, the passage 383, and the equipment B region 382 in this order to create the self-position estimation map.

In this case, when the mobile apparatus enters the passage 383 after moving in (scanning) the equipment A region 381, for example, due to the difference in space (width) and the difference in brightness, the change amount of the current distance to the surrounding object becomes larger than the threshold, and the change amount of the current light color tone becomes larger than the threshold, and the map of the self-position estimation map to be created is switched from the map of the equipment A region 381 to the map of the passage 383.

Next, when the mobile apparatus enters the equipment B region 382 after moving in (scanning) the passage 383, for example, due to the difference in space (width) and the difference in brightness, the change amount of the current distance to the surrounding object becomes larger than the threshold and the change amount of the current light color tone becomes larger than the threshold, and the self-position estimation map to be created is switched from the map of the passage 383 to the map of the equipment B region 382.

As described above, in the implementation environment of the factory 380, the self-position estimation map of the equipment A region 381, the passage 383, and the equipment B region 382 is separately created. Thus, for example, in a case where the layout is changed in the equipment A region 381 or the equipment B region 382, the mobile apparatus moves in (scans) only the region thereof, and the self-position estimation map can be easily changed. Therefore, since there is no map having overlapping regions, management is facilitated, and the storage capacity is not wastefully consumed.

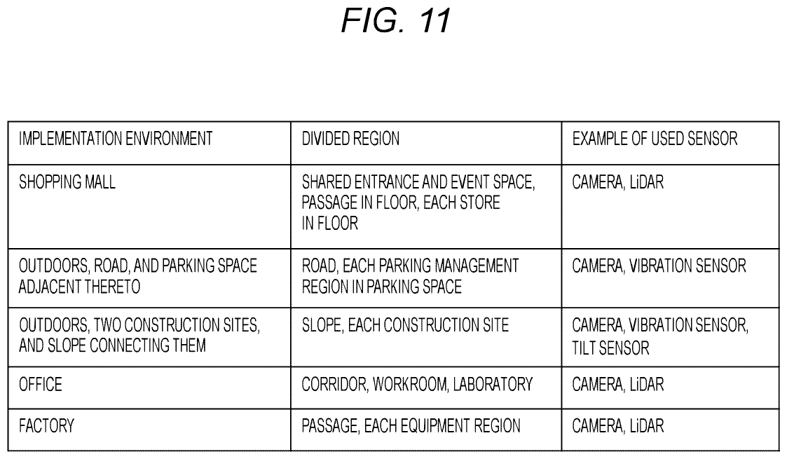

FIG. 11 illustrates an example of divided regions and sensors used for the region division in each implementation environment.

In a case where the implementation environment is the shopping mall 310 (see FIG. 6), the map is divided into respective regions of the shared entrance and event space 311, the passage 312, the store (store A) 313, and the store (store B) 314, and respective self-position estimation maps are created. Then, in this case, for example, a camera or LiDAR is used as a sensor for recognizing the surrounding environment used for the map switching determination. In this case, the change amount of the current light color tone is acquired on the basis of image information obtained by the camera. In addition, the change amount of the current distance to the surrounding object is acquired on the basis of the distance information to the surrounding object obtained by LiDAR.

In addition, in a case where the implementation environment is outdoors and the road 320 and the parking space 330 adjacent thereto (see FIG. 7), the map is divided into respective regions of the road 320, the parking management region 331 of the parking space 330, and the parking management region 332 of the parking space 330, and respective self-position estimation maps are created. Then, in this case, for example, a camera or a vibration sensor is used as a sensor for recognizing the surrounding environment used for the map switching determination. In this case, the change amount of the current light color tone is acquired on the basis of image information obtained by the camera. In addition, the change amount of the current vibration is acquired on the basis of the output of the vibration sensor.

In addition, in a case where the implementation environment is outdoors and is the two construction sites 340 and 350 and the slope 360 connecting the two construction sites (see FIG. 8), the map is divided into respective regions of the construction site 340, the slope 360, and the construction site 350, and respective self-position estimation maps are created. Then, in this case, for example, a camera, a vibration sensor, or an inclination sensor is used as a sensor for recognizing the surrounding environment used for the map switching determination. In this case, the change amount of the current light color tone is acquired on the basis of image information obtained by the camera. In addition, the change amount of the current vibration is acquired on the basis of the output of the vibration sensor. In addition, the change amount of the current inclination is acquired on the basis of the output of the inclination sensor.

In addition, in a case where the implementation environment is the office 370 (see FIG. 9), the map is divided into respective regions of the corridor 371, the workroom 372, and the laboratory 373, and respective self-position estimation maps are created. Then, in this case, for example, a camera or LiDAR is used as a sensor for recognizing the surrounding environment used for the map switching determination. In this case, the change amount of the current light color tone is acquired on the basis of image information obtained by the camera. In addition, the change amount of the current distance to the surrounding object is acquired on the basis of the distance information to the surrounding object obtained by LiDAR.

In addition, in a case where the implementation environment is the factory 380 (see FIG. 10), the map is divided into respective regions of the equipment A region 381, the passage 383, and the equipment B region 382, and respective self-position estimation maps are created. Then, in this case, for example, a camera or LiDAR is used as a sensor for recognizing the surrounding environment used for the map switching determination. In this case, the change amount of the current light color tone is acquired on the basis of image information obtained by the camera. In addition, the change amount of the current distance to the surrounding object is acquired on the basis of the distance information to the surrounding object obtained by LiDAR.

Returning to FIG. 3, as described above, the created map switching determination unit 114 determines the map switching timing further on the basis of the creation status of the map in the self-position estimation map creation unit 113, for example. For example, the creation status of the map includes, for example, a creation amount of the map. For example, the creation amount of the map is determined on the basis of the distance traveled by the mobile apparatus to create the current map. Furthermore, for example, the creation amount of the map is determined on the basis of the data amount of the currently created map.

The created map switching determination unit 114 determines that it is the map switching timing when the current creation amount map_ammountga of the map is larger than the threshold threshold_map_ammount of the creation amount of the map.

In addition, the creation status of the map includes, for example, a node arrangement instruction by the user. In this case, the node is arranged at a point where the mobile apparatus frequently goes. This node is a clear feature point input by the user. The created map switching determination unit 114 determines that it is the map switching timing when the node arrangement instruction by the user is given.

In this manner, by determining the map switching timing on the basis of the creation status of the map, the map used by the mobile apparatus is divided on the basis of the creation status of the map, and thus, for example, a map having a size suitable for the performance (map switching speed performance, map deployment performance on a memory, or the like) of the mobile apparatus can be created.

Furthermore, as described above, the created map switching determination unit 114 determines the map switching timing further on the basis of, for example, a user operation. When map switching is instructed by a user operation, the created map switching determination unit 114 determines that it is the map switching timing.

For example, the map switching instruction by the user operation may be performed on the basis of a display or utterance (for example, “do you want to switch to map at this point?”) that prompts an instruction of the user in the interaction unit 115. In this case, for example, when it is determined that the map should be switched according to the observation data (surrounding environment recognition result) obtained by the observation data acquisition unit 111 described above, the creation status of the map in the self-position estimation map creation unit 113, or the like, the interaction unit 115 displays or utters to prompt the user to give an instruction. Furthermore, for example, the map switching instruction by the user operation may be performed on the basis of the subjectivity of the user.

In this manner, by determining the map switching timing on the basis of the user operation, the map used in the mobile apparatus is divided further on the basis of the user's intention, and the map can be configured as intended by the user.

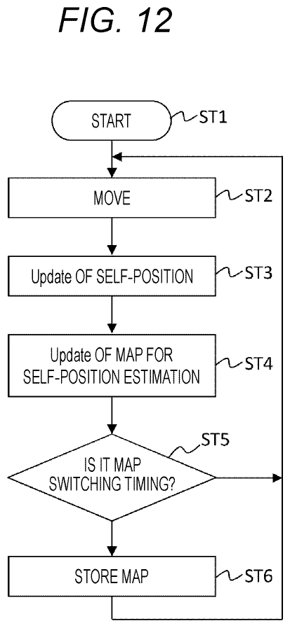

The flowchart of FIG. 12 illustrates an outline of a map creation operation by the map creation processing unit 100 illustrated in FIG. 3. First, in step ST1, the map creation processing unit 100 starts map creation processing.

Next, in step ST2, the map creation processing unit 100 moves the position and attitude of the mobile apparatus by a predetermined amount. Next, in step ST3, the map creation processing unit 100 updates the self-position (position and attitude) on the basis of the estimation result of the self-position estimation unit 112, and in step ST4, updates the self-position estimation map on the basis of the creation result of the self-position estimation map creation unit 113.

Next, in step ST5, the map creation processing unit 100 causes the created map switching determination unit 114 to determine whether or not it is a map switching timing. In this case, as described above, the created map switching determination unit 114 makes a map switching determination on the basis of the observation data (surrounding environment recognition result) obtained by the observation data acquisition unit 111, the creation status of the map in the self-position estimation map creation unit 113, the user operation, and the like.

In a case where it is determined in step ST5 that it is not the map switching timing, the map creation processing unit 100 returns to the processing of step ST2 and repeats processing similar to as described above. On the other hand, in a case where it is determined in step ST5 that it is the map switching timing, the map creation processing unit 100 stores the map created by the self-position estimation map creation unit 113 so far in step ST6 as one self-position estimation map in the map storage unit 116, and then returns to the processing of step ST2 for creating the next self-position estimation map.

Note that the map creation processing unit 100 ends the map creation processing automatically or on the basis of a user operation, for example, after the mobile apparatus moves in (scans) all the planned regions of the implementation environment.

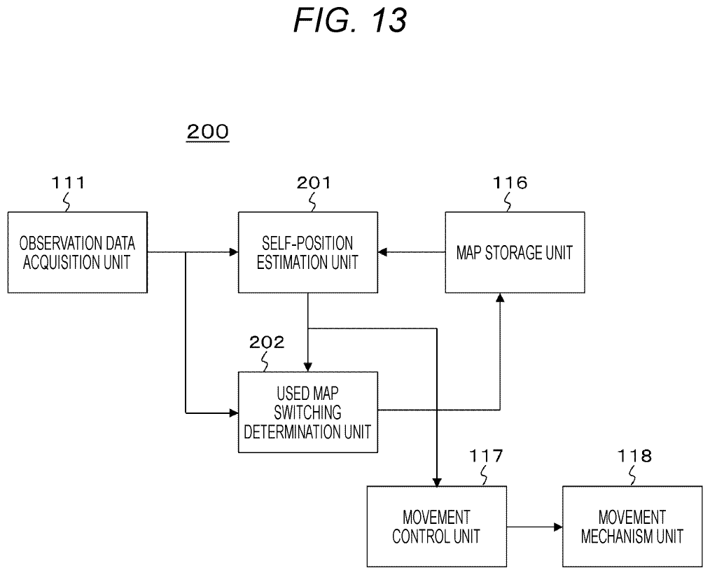

FIG. 13 illustrates a configuration example of a self-position estimation processing unit 200 in the self-position estimation system of the mobile apparatus as an autonomous mobile body such as a robot or a car, for example. In FIG. 13, portions corresponding to those in FIG. 3 are denoted by the same reference numerals, and detailed description thereof is appropriately omitted. The self-position estimation processing unit 200 estimates the position and the attitude using the self-position estimation map created by the map creation processing unit 100 described above, and controls the movement of the mobile apparatus on the basis of the estimation result.

The self-position estimation processing unit 200 includes the observation data acquisition unit 111, the map storage unit 116, a self-position estimation unit 201, a used map switching determination unit 202, the movement control unit 117, and the movement mechanism unit 118. Here, the observation data acquisition unit 111, the map storage unit 116, the movement control unit 117, and the movement mechanism unit 118 can be commonly used in the above-described map creation processing unit 100. The map storage unit 116 stores the self-position estimation map (for example, a key frame map) created by the map creation processing unit 100 of FIG. 3.

The self-position estimation unit 201 performs matching processing between the captured image data obtained by the observation data acquisition unit 111 and a self-position estimation map (for example, a key frame map) stored in the map storage unit 116 to estimate the position and the attitude of the mobile apparatus.

The used map switching determination unit 202 makes a map switching determination on the basis of the observation data (surrounding environment recognition result) obtained by the observation data acquisition unit 111. Note that the created map switching determination unit 114 illustrated in FIG. 3 makes a map switching determination on the basis of the observation data (surrounding environment recognition result) obtained by the observation data acquisition unit 111, the creation status of the map in the self-position estimation map creation unit 113, the user operation, and the like, but here, the map switching determination based on only the observation data (surrounding environment recognition result) obtained by the observation data acquisition unit 111 is made.

Then, the used map switching determination unit 202 refers to the determination that the map switching determination result indicates the switching timing, and on the basis of the position estimation result estimated by the self-position estimation unit 201, reads the self-position estimation map of the region to be used by the self-position estimation unit 201 from the self-position estimation maps of the plurality of regions stored in the map storage unit 116, and supplies the self-position estimation map to the self-position estimation unit 201. Thus, the self-position estimation map used by the self-position estimation unit 201 is sequentially updated to an appropriate map according to the movement position of the mobile apparatus.

The movement control unit 117 controls the movement of the mobile apparatus on the basis of the position and attitude estimated by the self-position estimation unit 201, and specifically, the movement control unit 117 calculates a direction, a distance, a speed, and the like to move from the position and attitude estimated by the self-position estimation unit 201 and route information, and controls the moving mechanism 118 on the basis of the result.

### Configuration Example of Computer

The above-described processing of the map creation processing unit 100 illustrated in FIG. 3 and the series of processes in the self-position estimation processing unit 200 illustrated in FIG. 13 can be executed by hardware, but can also be executed by software. In a case where the series of processes is executed by software, a program constituting the software is installed from a recording medium into, for example, a computer built into dedicated hardware or a general-purpose computer that is capable of executing various functions by installing various programs, or the like.

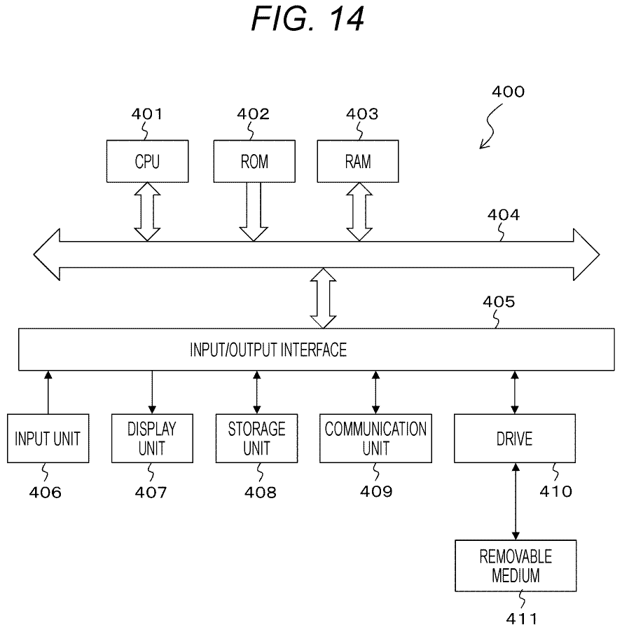

FIG. 14 is a block diagram illustrating a configuration example of hardware of a computer 400 that executes the above-described series of processes by a program.

In the computer 400, a central processing unit (CPU) 401, a read only memory (ROM) 402, and a random access memory (RAM) 403 are mutually connected by a bus 404.

The bus 404 is further connected with an input/output interface 405. To the input/output interface 405, an input unit 406, an output unit 407, a recording unit 408, a communication unit 409, and a drive 410 are connected.

The input unit 406 includes an input switch, a button, a microphone, an image sensor, and the like. The output unit 407 includes a display, a speaker, and the like. The recording unit 408 includes a hard disk, a non-volatile memory, and the like. The communication unit 409 includes a network interface or the like. The drive 410 drives a removable recording medium 411 such as a magnetic disk, an optical disk, a magneto-optical disk, or a semiconductor memory.

In the computer 400 configured as described above, the CPU 401 loads, for example, a program recorded in the recording unit 408 into the RAM 403 via the input/output interface 405 and the bus 404, and executes the program, so as to perform the above-described series of processes.

The program executed by the computer 400 (the CPU 401) can be provided by being recorded on, for example, the removable recording medium 411 as a package medium or the like. Furthermore, the program can be provided via a wired or wireless transmission medium such as a local area network, the Internet, or digital satellite broadcasting.

In the computer 400, the program can be installed in the recording unit 408 via the input/output interface 405 by mounting the removable recording medium 411 to the drive 410. Furthermore, the program can be received by the communication unit 409 via a wired or wireless transmission medium, and installed in the recording unit 408. In addition, the program can be pre-installed in the ROM 402 or the recording unit 408.

Note that the program executed by the computer may be a program in which processing is performed in time series in the order described in the present specification, or may be a program in which processing is performed in parallel or at necessary timing such as when a call is made, and the like.

Furthermore, in the present specification, a system is intended to mean assembly of a plurality of components (devices, modules (parts) and the like) and it does not matter whether or not all the components are in the same casing. Therefore, a plurality of devices housed in separate housings and connected via a network and one device in which a plurality of modules is housed in one housing are both systems.

Moreover, the embodiments of the present technology are not limited to the above-described embodiments, and various modifications can be made without departing from the gist of the present technology.

For example, the present technology can be configured as cloud computing in which one function is shared by a plurality of devices through a network for processing in cooperation.

Furthermore, each step described in the above-described flowchart can be executed by one device or executed by a plurality of devices in a shared manner.

Moreover, in a case where a plurality of processes is included in one step, the plurality of processes included in one step can be executed by one device or by a plurality of devices in a shared manner.

As described above, in the present technology, the map creation processing unit 100 determines map switching (end of creation of the first map and start of creation of the second map) on the basis of the recognition result of the surrounding environment, and on the basis of the result, a plurality of implementation environments is divided into a plurality of regions, and maps of respective regions are created. Therefore, since the map used in the mobile apparatus is divided on the basis of the surrounding environment, management and update can be performed satisfactorily.

Furthermore, in the present technology, the map creation processing unit 100 determines map switching (end of creation of the first map and start of creation of the second map) further on the basis of the creation status of the map, and on the basis of the result, a plurality of implementation environments is divided into a plurality of regions, and maps of respective regions are created. Therefore, for example, it is possible to create a map having a size suitable for the performance (map switching speed performance, map deployment performance on memory, or the like) of the mobile apparatus of the mobile apparatus.

Furthermore, in the present technology, the map creation processing unit 100 determines map switching (end of creation of the first map and start of creation of the second map) further on the basis of the user operation, and on the basis of the result, a plurality of implementation environments is divided into a plurality of regions, and maps of respective regions are created. Therefore, the map used in the mobile apparatus is divided on the basis of the intention of the user, and the map configuration can be as intended by the user.

### 3. Modifications

Note that the preferred embodiments of the present disclosure have been described in detail with reference to the accompanying drawings, but the technical scope of the present disclosure is not limited to such examples. It is apparent that a person having ordinary knowledge in the technical field of the present disclosure can devise various change examples or modification examples within the scope of the technical idea described in the claims, and it will be naturally understood that they also belong to the technical scope of the present disclosure.

Furthermore, the effects described in the present specification are merely explanatory or exemplary, and are not restrictive. That is, the technology according to the present disclosure can exhibit other effects apparent to those skilled in the art from the description of the present specification, in addition to the effect above or instead of the effect above.

Furthermore, the present technology can also have the following configurations.

(1) An information processing device, including:
a map creation unit that creates at least a first map and a second map on the basis of a first recognition result of a surrounding environment; and
a created map switching determination unit that determines an end of creation of the first map and a start of creation of the second map on the basis of a second recognition result of a surrounding environment.

(2) The information processing device according to (1) above, in which
the first map and the second map are maps of adjacent regions.

(3) The information processing device according to (1) or (2) above, in which
each of the first map and the second map is a map whose range is a region having similar environmental information.

(4) The information processing device according to any one of (1) to (3) above, in which
the map created by the map creation unit is a self-position estimation map.

(5) The information processing device according to any one of (1) to (4) above, in which
the second recognition result includes a change amount of a current light color tone.

(6) The information processing device according to any one of (1) to (5) above, in which
the second recognition result includes a change amount of a current distance to a surrounding object.

(7) The information processing device according to any one of (1) to (6) above, in which
the second recognition result includes a change amount of a current vibration amount.

(8) The information processing device according to any one of (1) to (7) above, in which
the second recognition result includes a change amount of a current inclination.

(9) The information processing device according to any one of (1) to (8) above, in which
the created map switching determination unit determines the end of creation of the first map and the start of creation of the second map further on the basis of a creation status of the map in the map creation unit.

(10) The information processing device according to (9) above, in which
the creation status of the map includes a creation amount of the map.

(11) The information processing device according to (10) above, in which
the creation amount of the map is determined on the basis of a distance traveled to create a current map of a mobile apparatus including the information processing device.

(12) The information processing device according to (10) above, in which
the creation amount of the map is determined on the basis of a data amount of a currently created map.

(13) The information processing device according to (9) above, in which
the creation status of the map includes a node arrangement instruction by a user.

(14) The information processing device according to any one of (1) to (13) above, in which
the created map switching determination unit determines the end of creation of the first map and the start of creation of the second map further on the basis of a user operation.

(15) The information processing device according to any one of (1) to (14) above, further including:
a map holding unit that holds a plurality of maps including at least the first map and the second map;
a used map switching determination unit that switches the plurality of the maps on the basis of a change in a surrounding environment; and
a self-position estimation unit that estimates a self-position on the basis of the map used.

(16) An information processing method, including:
a mapping procedure of creating at least a first map and a second map on the basis of a first recognition result of a surrounding environment; and
a created map switching determination procedure of determining completion of creation of the first map and start of creation of the second map on the basis of a second recognition result of a surrounding environment.

(17) A program causing a computer to function as:
a map creation unit that creates at least a first map and a second map on the basis of a first recognition result of a surrounding environment; and
a created map switching determination unit that determines an end of creation of the first map and a start of creation of the second map on the basis of a second recognition result of a surrounding environment.

(18) A mobile apparatus including an information processing device, in which
the information processing device includes:
a map creation unit that creates at least a first map and a second map on the basis of a first recognition result of a surrounding environment; and
a created map switching determination unit that determines an end of creation of the first map and a start of creation of the second map on the basis of a second recognition result of a surrounding environment.

### REFERENCE SIGNS LIST

100 Map creation processing unit
111 Observation data acquisition unit
112 Self-position estimation unit
113 Self-position estimation map creation unit
114 Created map switching determination unit
115 Interaction unit
116 Map storage unit
117 Movement control unit
118 Movement mechanism unit
200 Self-position estimation processing unit
201 Self-position estimation unit
202 Used map switching determination unit

1. An information processing device, comprising:
a map creation unit that creates at least a first map and a second map on a basis of a first recognition result of a surrounding environment; and
a created map switching determination unit that determines an end of creation of the first map and a start of creation of the second map on a basis of a second recognition result of a surrounding environment.

2. The information processing device according to claim 1, wherein
the first map and the second map are maps of adjacent regions.

3. The information processing device according to claim 1, wherein
each of the first map and the second map is a map whose range is a region having similar environmental information.

4. The information processing device according to claim 1, wherein
the map created by the map creation unit is a self-position estimation map.

5. The information processing device according to claim 1, wherein
the second recognition result includes a change amount of a current light color tone.

6. The information processing device according to claim 1, wherein
the second recognition result includes a change amount of a current distance to a surrounding object.

7. The information processing device according to claim 1, wherein
the second recognition result includes a change amount of a current vibration amount.

8. The information processing device according to claim 1, wherein
the second recognition result includes a change amount of a current inclination.

9. The information processing device according to claim 1, wherein
the created map switching determination unit determines the end of creation of the first map and the start of creation of the second map further on a basis of a creation status of the map in the map creation unit.

10. The information processing device according to claim 9, wherein
the creation status of the map includes a creation amount of the map.

11. The information processing device according to claim 10, wherein
the creation amount of the map is determined on a basis of a distance traveled to create a current map of a mobile apparatus including the information processing device.

12. The information processing device according to claim 10, wherein
the creation amount of the map is determined on a basis of a data amount of a currently created map.

13. The information processing device according to claim 9, wherein
the creation status of the map includes a node arrangement instruction by a user.

14. The information processing device according to claim 1, wherein
the created map switching determination unit determines the end of creation of the first map and the start of creation of the second map further on a basis of a user operation.

15. The information processing device according to claim 1, further comprising:
a map holding unit that holds a plurality of maps including at least the first map and the second map;
a used map switching determination unit that switches the plurality of the maps on a basis of a change in a surrounding environment; and
a self-position estimation unit that estimates a self-position on a basis of the map used.

16. An information processing method, comprising:
a mapping procedure of creating at least a first map and a second map on a basis of a first recognition result of a surrounding environment; and
a created map switching determination procedure of determining completion of creation of the first map and start of creation of the second map on a basis of a second recognition result of a surrounding environment.

17. A program causing a computer to function as:
a map creation unit that creates at least a first map and a second map on a basis of a first recognition result of a surrounding environment; and
a created map switching determination unit that determines an end of creation of the first map and a start of creation of the second map on a basis of a second recognition result of a surrounding environment.

18. A mobile apparatus comprising an information processing device, wherein
the information processing device includes:
a map creation unit that creates at least a first map and a second map on a basis of a first recognition result of a surrounding environment; and
a created map switching determination unit that determines an end of creation of the first map and a start of creation of the second map on a basis of a second recognition result of a surrounding environment.
